(19) United States
(12) Patent Application Publication
(10) Pub. No.: US 2026/0249365 A1
(43) Pub. Date: Aug. 27, 2026

(54) HANDHELD POWER TOOL

(71) Applicant: NANJING CHERVON INDUSTRY CO., LTD., Nanjing (CN)

(72) Inventors: Yonghui CHENG, Nanjing (CN); Xu WU, Nanjing (CN); Shubin TONG, Nanjing (CN); Xiang ZHANG, Nanjing (CN); Rong WANG, Nanjing (CN)

(73) Assignee: NANJING CHERVON INDUSTRY CO., LTD., Nanjing (CN)

(21) Appl. No.: 19/651,882

(22) Filed: Apr. 20, 2026

Related U.S. Application Data
(63) Continuation of application No. PCT/CN2024/136442, filed on Dec. 3, 2024.

(30) Foreign Application Priority Data
Dec. 15, 2023 (CN) 202311729091.8
Dec. 15, 2023 (CN) 202311733949.8
Dec. 15, 2023 (CN) 202311736367.5
Dec. 15, 2023 (CN) 202311736371.1
Dec. 15, 2023 (CN) 202323436620.3

(51) Int. Cl. B23B 45/02; B23B 45/00

(52) U.S. Cl. CPC B23B 45/02; B23B 45/001; B23B 45/008

(57) ABSTRACT

Provided is a handheld power tool, including: an output shaft that defines an output axis; and an output housing that defines a first central axis passing through a geometric center, where a radial distance from the first central axis to an outer edge of the output housing is R; the output shaft includes a first position and a second position; when the output shaft is at the first position, a radial distance from the output axis to the first central axis is D1; and when the output shaft is at the second position, the radial distance from the output axis to the first central axis is D2, D1 being less than D2, D1 being greater than or equal to 0 and less than R, and D2 being greater than 0 and less than or equal to R.

### RELATED APPLICATION INFORMATION

This application is a continuation of International Application Number PCT/CN2024/136442 filed on Dec. 3, 2024, through which this application also claims the benefit under 35 U.S.C. § 119(a) of Chinese Patent Application No. 202311736371.1 filed on Dec. 15, 2023, Chinese Patent Application No. 202311733949.8 filed on Dec. 15, 2023, Chinese Patent Application No. 202311736367.5 filed on Dec. 15, 2023, Chinese Patent Application No. 202311729091.8 filed on Dec. 15, 2023, and Chinese Patent Application No. 202323436620.3 filed on Dec. 15, 2023, which application are incorporated herein by reference in their entireties.

### TECHNICAL FIELD

The present disclosure relates to the field of power tools, and in particular, to a handheld power tool.

### BACKGROUND

In the related art, handheld power tools have been widely used due to their convenience and high output efficiency. During operation, it is common to encounter one-sided obstructions at wall-floor junctions, interiors of cabinets, or other scenarios requiring an offset output shaft. In the related art, for the handheld power tools and particularly fastening tools, the output shaft is substantially located at a relatively central position of the tool to ensure stable torque output. However, in case of edge-following conditions, the tool often needs to be inclined for operation, which may easily lead to the scrapping of fasteners or damage to the workpiece.

This part is merely intended to provide background information related to the present disclosure, and does not necessarily constitute the prior art.

### SUMMARY

The present disclosure can solve or at least alleviate a part or all of the aforementioned problems. In view of this, the present disclosure provides a handheld power tool capable of offsetting an output shaft.

A handheld power tool includes: a motor that includes a drive shaft rotating about a first axis; a drive housing that at least accommodates the motor; an output shaft that defines an output axis, the output shaft rotating about the output axis to output power; and an output housing that is configured to support rotation of the output shaft, the output housing defining a first central axis passing through a geometric center; where a radial distance from the first central axis to an outer edge of the output housing is R; the output shaft includes a first position and a second position; when the output shaft is at the first position, a radial distance from the output axis to the first central axis is D1; and when the output shaft is at the second position, the radial distance from the output axis to the first central axis is D2, D1 being less than D 2, D1 being greater than or equal to 0 and less than R, and D2 being greater than 0 and less than or equal to R.

In some embodiments, the output housing rotates relative to the drive housing about the first central axis.

In some embodiments, when the output shaft is at the second position, the output shaft rotates relative to the drive housing about the first central axis.

In some embodiments, the handheld power tool further includes a first locking portion that is configured to retain the output shaft at the first position or the second position.

In some embodiments, when the output shaft is at the first position, the output shaft rotates relative to the drive housing about the first central axis.

In some embodiments, the output shaft is provided with or connected to a clamping portion for connecting a working component; and the working component is configured to implement a function of the handheld power tool.

In some embodiments, the handheld power tool further includes a first bearing that supports rotation of the output shaft about the output axis; the output housing is provided with an accommodating portion; and the accommodating portion is configured to accommodate the first bearing.

In some embodiments, the handheld power tool further includes a second locking assembly that is configured to selectively lock rotation of the output housing relative to the drive housing.

In some embodiments, the output shaft rotates relative to the output housing about a third axis to switch between the first position and the second position; and the third axis is eccentric to the first central axis.

In some embodiments, the handheld power tool further includes a transmission mechanism that is configured to connect the drive shaft and the output shaft; the transmission mechanism is provided with a transmission shaft defining a second axis; the transmission shaft drives the output shaft; and when the output shaft is at the first position or the second position, the output axis is radially offset from the second axis.

In some embodiments, the handheld power tool further includes a second housing that rotates relative to the drive housing; when the handheld power tool is in an offset state in which the output axis is radially offset from the second axis, a position of the output axis relative to the second axis is adjusted by rotating the second housing; and a length from a rear end of the second housing to an end of the output shaft extending out of the second housing is less than or equal to 56 mm.

In some embodiments, the handheld power tool includes a first state in which the output axis is substantially coaxial with the second axis and a second state in which the output axis is radially offset from the second axis; and when the handheld power tool is in the first state, the output axis is substantially coaxial with the first central axis.

In some embodiments, the handheld power tool includes a clutch assembly; the clutch assembly is connected between the transmission shaft and the output shaft; and the clutch assembly is selectively connected to the transmission shaft and the output shaft at the first position, or the transmission shaft and the output shaft at the second position.

In some embodiments, the clutch assembly includes an engaged state for torque transmission between the transmission shaft and the output shaft and a disengaged state for transmission interruption between the transmission shaft and the output shaft; and when the clutch assembly is in the disengaged state, the output shaft is configured to move in a direction perpendicular to the first axis.

In some embodiments, when the clutch assembly is in the disengaged state, the output shaft is switched between the first position and the second position.

An embodiment of the present disclosure provides a handheld power tool, including: a motor that includes a drive shaft rotating about a first axis; a drive housing that at least accommodates the motor; an output shaft that defines an output axis, the output shaft rotating about the output axis to output power; and an output housing that is configured to support rotation of the output shaft, the output housing defining a first central axis passing through a geometric center; where the output shaft includes a first position and a second position; when the output shaft is at the first position, a radial distance from the output axis to the first central axis is D1; and when the output shaft is at the second position, the radial distance from the output axis to the first central axis is D2, D1 being not the same as D2.

An embodiment of the present disclosure provides a handheld power tool, including: a motor that includes a drive shaft rotating about a first axis; a drive housing that at least accommodates the motor; an output shaft that defines an output axis, the output shaft rotating about the output axis to output power; and an output housing that is configured to support rotation of the output shaft, the output housing defining a first central axis passing through a geometric center; where the output shaft moves relative to the output housing, such that the output axis is radially offset relative to the first central axis.

In some embodiments, the output shaft rotates relative to the output housing about a third axis; and the third axis is eccentric to the first central axis.

In some embodiments, the output shaft is provided with or connected to a clamping portion for connecting a working component; and the working component is configured to implement a function of the handheld power tool.

In some embodiments, the handheld power tool further includes a first bearing that supports rotation of the output shaft about the output axis; the output housing is provided with an accommodating portion; and the accommodating portion is configured to accommodate the first bearing.

An embodiment of the present disclosure provides a handheld power tool, including: a motor that includes a drive shaft rotating about a first axis; a drive housing that is configured to at least accommodate the motor; an output shaft that defines an output axis, the output shaft rotating about the output axis to output power; a transmission mechanism that is connected to the drive shaft, the transmission mechanism being provided with a transmission shaft for driving the output shaft, the transmission shaft defining a second axis, and the transmission shaft rotating about the second axis; and an output housing that is configured to support rotation of the output shaft, the output housing defining a first central axis passing through a geometric center; where the handheld power tool includes a first state in which the output axis is substantially coaxial with the second axis and a second state in which the output axis is radially offset from the second axis; and in the first state, the output axis is substantially coaxial with the first central axis.

In some embodiments, the output shaft rotates relative to the output housing about a third axis; and the third axis is eccentric to the first central axis.

In some embodiments, the output shaft includes a first position where a radial distance from the output axis to the first central axis is D1 and a second position where the radial distance from the output axis to the first central axis is D2.

In some embodiments, when the handheld power tool is in the second state, the output shaft is displaced radially to the second position relative to the output housing about the third axis.

In some embodiments, when the handheld power tool is in the first state, the output shaft is located at the first position; and at the first position, the output axis is substantially coaxial with the first central axis.

In some embodiments, the output housing rotates relative to the drive housing about the first central axis.

In some embodiments, the output shaft is provided with or connected to a clamping portion for connecting a working component; and the working component is configured to implement a function of the handheld power tool.

In some embodiments, the handheld power tool further includes a first bearing that supports rotation of the output shaft about the output axis; the output housing is provided with an accommodating portion; and the accommodating portion is configured to mount the first bearing.

In some embodiments, the handheld power tool includes a clutch assembly; the clutch assembly is connected between the transmission shaft and the output shaft; and the clutch assembly is selectively connected to the transmission shaft and the output shaft at the first position, or the transmission shaft and the output shaft at the second position.

An embodiment of the present disclosure provides a handheld power tool, including: a motor that includes a drive shaft rotating about a first axis; a drive housing that is configured to at least accommodate the motor; an output shaft that defines an output axis, the output shaft rotating about the output axis to output power; a transmission mechanism that is configured to connect the drive shaft and the output shaft, the transmission mechanism being provided with a transmission shaft for connecting the output shaft, the transmission shaft defining a second axis, and the transmission shaft rotating about the second axis; and an output housing that is configured to support rotation of the output shaft, the output housing defining a first central axis passing through a geometric center; where the handheld power tool includes a first state in which the output axis is substantially coaxial with the second axis and a second state in which the output axis is radially offset from the second axis; and in the first state, radial distances from the output axis to an outer edge of the output housing in a same radial direction are respectively L1 and L2, a ratio of L1 to L2 being greater than or equal to 0.4 and less than or equal to 1.

In some embodiments, in the first state, the radial distances from the output axis to the outer edge of the output housing in the same radial direction are respectively L1 and L2, a ratio of L1 to L2 being greater than or equal to 0.6 and less than or equal to 1.

In some embodiments, in the first state, the radial distances from the output axis to the outer edge of the output housing in the same radial direction are respectively L1 and L2, a ratio of L1 to L2 being greater than or equal to 0.8 and less than or equal to 1.

An embodiment of the present disclosure provides a handheld power tool, including: a motor that includes a drive shaft rotating about a first axis; a drive housing that is configured to at least accommodate the motor; an output shaft that defines an output axis, the output shaft rotating about the output axis to output power; a transmission mechanism that is configured to connect the drive shaft and the output shaft, the transmission mechanism being provided with a transmission shaft for connecting the output shaft; and a clutch assembly that is disposed between the transmission shaft and the output shaft; where the clutch assembly includes an engaged state for torque transmission between the transmission shaft and the output shaft and a disengaged state for transmission interruption between the transmission shaft and the output shaft; and when the clutch assembly is in the disengaged state, the output shaft is configured to move in a direction perpendicular to the first axis.

In some embodiments, the handheld power tool further includes an output housing that is configured to support rotation of the output shaft; the output housing defines a first central axis passing through a geometric center; and the output shaft includes a first position where a radial distance from the output axis to the first central axis is D1 and a second position where the radial distance from the output axis to the first central axis is D2.

In some embodiments, when the clutch assembly is in the disengaged state, the output shaft is switched between the first position and the second position.

In some embodiments, the clutch assembly includes a first locking portion that is configured to retain the output shaft at the first position or the second position.

In some embodiments, the first locking portion includes a first limiting portion corresponding to the first position and a second limiting portion corresponding to the second position; and the output shaft is selectively connected to the first limiting portion or the second limiting portion at a corresponding position.

In some embodiments, the clutch assembly further includes a restoring member that is configured to drive the clutch assembly to switch from the disengaged state to the engaged state.

In some embodiments, the output shaft is provided with or connected to a clamping portion for connecting a working component; and the working component is configured to implement a function of the handheld power tool.

In some embodiments, the handheld power tool further includes a first bearing that supports rotation of the output shaft about the output axis; the output housing is provided with an accommodating portion; and the accommodating portion is configured to accommodate the first bearing.

In some embodiments, the output shaft rotates relative to the output housing about a third axis; and the third axis is eccentric to the first central axis.

In some embodiments, the clutch assembly rotates synchronously with the output housing.

An embodiment of the present disclosure provides a handheld power tool, including: a motor that includes a drive shaft rotating about a first axis; a drive housing that is configured to at least accommodate the motor; an output shaft that defines an output axis, the output shaft rotating about the output axis to output power; a transmission mechanism that is configured to connect the drive shaft, the transmission mechanism being provided with a transmission shaft; and an output transmission assembly that is disposed between the transmission shaft and the output shaft; where the output transmission assembly includes an input portion connected to the transmission shaft and an output portion connected to the output shaft; the output portion includes a first transmission gear and a second transmission gear; and the output shaft is selectively coupled to the first transmission gear or the second transmission gear, so as to transmit power of the transmission shaft to the output shaft.

In some embodiments, the handheld power tool further includes an output housing that is configured to support rotation of the output shaft; the output housing defines a first central axis passing through a geometric center; and the output shaft includes a first position where a radial distance from the output axis to the first central axis is D1 and a second position where the radial distance from the output axis to the first central axis is D2.

In some embodiments, when the output shaft is at the first position, the output shaft is coupled to the first transmission gear.

In some embodiments, an axis of the first transmission gear is substantially parallel to an axis of the second transmission gear; and the first transmission gear and the second transmission gear have a same rotation direction.

In some embodiments, the output shaft further includes a third transmission gear; and the third transmission gear is in transmission connection with the first transmission gear and the second transmission gear.

In some embodiments, the output shaft is provided with or connected to a clamping portion for connecting a working component; and the working component is configured to implement a function of the handheld power tool.

In some embodiments, the handheld power tool further includes a first bearing that supports rotation of the output shaft about the output axis; the output housing is provided with an accommodating portion; and the accommodating portion is configured to accommodate the first bearing.

In some embodiments, the output housing rotates relative to the drive housing about the first central axis.

In some embodiments, the output shaft rotates relative to the output housing about a third axis; and the third axis is eccentric to the first central axis.

In some embodiments, an axis of at least one of the first transmission gear and the second transmission gear is offset from the first central axis; and when the output housing rotates relative to the drive housing about the first central axis, the offset transmission gear rotates relative to the drive housing about the first central axis.

An embodiment of the present disclosure provides a handheld power tool, including: a motor that includes a drive shaft rotating about a first axis; a drive housing that is configured to at least accommodate the motor; an output shaft that defines an output axis, the output shaft rotating about the output axis to output power; a transmission mechanism that is configured to connect the drive shaft and the output shaft, the transmission mechanism being provided with a transmission shaft for driving the output shaft, the transmission shaft defining a second axis, and the transmission shaft rotating about the second axis; and a second housing that rotates relative to the drive housing; where the handheld power tool includes an offset state in which the output axis is radially offset from the second axis; a position of the output axis relative to the second axis is adjusted by rotating the second housing; and a length from a rear end of the second housing to an end of the output shaft extending out of the second housing is less than or equal to 56 mm.

In some embodiments, the length from the rear end of the second housing to the end of the output shaft extending out of the second housing is less than or equal to 50 mm.

In some embodiments, the second housing includes an output housing that is configured to support rotation of the output shaft; and the output housing defines a first central axis passing through a geometric center.

In some embodiments, the handheld power tool further includes a first bearing that supports rotation of the output shaft about the output axis; the output housing is provided with an accommodating portion; and the accommodating portion is configured to accommodate the first bearing.

In some embodiments, the output shaft includes a first position where a radial distance from the output axis to the first central axis is D1 and a second position where the radial distance from the output axis to the first central axis is D2.

In some embodiments, the output shaft is provided with or connected to a clamping portion for connecting a working component; and the working component is configured to implement a function of the handheld power tool.

In some embodiments, the handheld power tool further includes an output transmission assembly; and the output transmission assembly is disposed between the transmission shaft and the output shaft.

In some embodiments, the output transmission assembly includes a first transmission gear and a second transmission gear; the output shaft is selectively coupled to the first transmission gear or the second transmission gear; and the first transmission gear and the second transmission gear are disposed on a first plane of a gear carrier.

In some embodiments, when the output shaft is at the second position, the output shaft rotates relative to the drive housing about the first central axis.

In some embodiments, a radial distance from the first central axis to an outer edge of the output housing is R, D1 is less than D2, D1 is greater than or equal to 0 and less than R, and D2 is greater than 0 and less than or equal to R.

An embodiment of the present disclosure provides a handheld power tool, including: a motor that includes a drive shaft rotating about a first axis; a drive housing that at least accommodates the motor; an output shaft that defines an output axis, the output shaft rotating about the output axis to output power; and a transmission mechanism that is configured to connect the drive shaft, the transmission mechanism being provided with a transmission shaft.

In some embodiments, the handheld power tool further includes: an output transmission assembly that is disposed between the transmission shaft and the output shaft, the output transmission assembly including an input portion connected to the transmission shaft and an output portion connected to the output shaft; and a first intermediate gear, where the output shaft is rotatably connected to the first intermediate gear; the output shaft rotates relative to the first intermediate gear about the output axis; and the first intermediate gear is driven to rotate about a third axis, such that the output shaft rotates about the third axis.

In some embodiments, the handheld power tool further includes an output housing that is configured to support rotation of the output shaft; the output housing defines a first central axis passing through a geometric center; and the output shaft includes a first position where a radial distance from the output axis to the first central axis is D1 and a second position where the radial distance from the output axis to the first central axis is D2, D1 being less than D2.

In some embodiments, the output shaft rotates relative to the output housing about a third axis to switch between the first position and the second position.

In some embodiments, the first intermediate gear is driven to rotate about the third axis, such that the output portion rotates about the third axis. In some embodiments, the output transmission assembly includes a transmission housing; the transmission housing at least accommodates a part of the first intermediate gear; and by rotating the transmission housing, the first intermediate gear is driven to rotate about the third axis.

In some embodiments, the transmission housing is connected to the output housing; and the transmission housing rotates relative to the output housing to drive the first intermediate gear.

In some embodiments, the first intermediate gear includes a fan-shaped gear that is driven to swing about the third axis to and fro, thereby driving the output shaft to switch between the first position and the second position.

In some embodiments, the fan-shaped gear is an external gear; and the transmission housing is circumferentially provided with first internal teeth.

In some embodiments, the first internal teeth are connected to external teeth of the first intermediate gear through an idle gear; the idle gear is disposed between the first internal teeth and the first intermediate gear; and the idle gear rotates about an idle gear shaft.

In some embodiments, the input portion includes a driving gear; the output portion includes a driven gear; the output portion is coaxial with the output shaft; and the output shaft rotates about the output axis.

In some embodiments, a second intermediate gear is disposed between the input portion and the output portion; and the output portion rotates in a same direction as the transmission shaft.

In some embodiments, the second intermediate gear rotates about the third axis.

In some embodiments, the second intermediate gear is externally engaged with the output portion; and the output portion is driven by the first intermediate gear to rotate about the third axis along a periphery of the second intermediate gear.

In some embodiments, when the output shaft is switched between the first position and the second position, the output portion is engaged with the second intermediate gear.

In some embodiments, a displacement limiting groove is formed in the output housing; and the displacement limiting groove is configured to at least indicate the first position and the second position of the output shaft.

An embodiment of the present disclosure provides a handheld power tool, including: a motor that includes a drive shaft rotating about a first axis; a drive housing that at least accommodates the motor; an output shaft that defines an output axis, the output shaft rotating about the output axis to output power; and an output housing that is configured to support rotation of the output shaft, the output housing defining a first central axis passing through a geometric center; where the output axis is offset from the first central axis; and the output housing rotates relative to the drive housing about the first central axis, such that the output shaft rotates relative to the drive housing about the first central axis.

In some embodiments, the handheld power tool further includes an output transmission assembly that is disposed between the drive shaft and the output shaft; and the output transmission assembly includes an input portion that inputs power and an output portion connected to the output shaft; and when the output shaft is at a second position, the output portion is offset from the input portion.

In some embodiments, the output transmission assembly includes a first inner toothed ring; and the input portion and the output portion are engaged with the first inner toothed ring.

In some embodiments, the input portion includes a driving gear disposed on or connected to a transmission shaft; the output portion includes a driven gear disposed on or connected to the output shaft; and the driving gear drives the first inner toothed ring to rotate, thereby driving the driven gear to rotate.

In some embodiments, a central axis of the first inner toothed ring is substantially coaxial with the first central axis.

In some embodiments, the output shaft rotates about the first central axis to switch between the first position and the second position; when the output shaft is at the first position, a radial distance from the output axis to the first axis is D1; and when the output shaft is at the second position, the radial distance from the output axis to the first axis is D2, D1 being less than D2.

In some embodiments, when the output shaft is switched between the first position and the second position, the driven gear rotates about the first central axis along inner teeth of the first inner toothed ring.

In some embodiments, the handheld power tool further includes a transmission mechanism that is configured to connect the drive shaft; the transmission mechanism is provided with a transmission shaft defining a second axis; the output shaft rotates about the first central axis to switch between the first position and the second position; when the output shaft is at the first position, a radial distance from the output axis to the second axis is D1; and when the output shaft is at the second position, the radial distance from the output axis to the second axis is D2, D1 being less than D2.

In some embodiments, the first central axis is offset from the second axis.

In some embodiments, the output housing is provided with an accommodating portion; and a first bearing configured to support rotation of the output shaft about the output axis is sleeved on the output shaft.

### BRIEF DESCRIPTION OF THE DRAWINGS

FIG. 1 is a structural view of a handheld power tool according to an embodiment of the present disclosure, where the handheld power tool is in a first state;

FIG. 2 is a structural view of a handheld power tool from another viewing angle according to an embodiment of the present disclosure, where an output shaft is at a first position;

FIG. 3 is a structural view of a handheld power tool according to an embodiment of the present disclosure, where an output shaft is at a second position;

FIG. 4 is a structural view of a handheld power tool from another viewing angle according to an embodiment of the present disclosure, where the handheld power tool is in a second state;

FIGS. 5A to 5C are schematic structural views when an output shaft of a handheld power tool is at a second position according to an embodiment of the present disclosure;

FIG. 6 is a structural view of the handheld power tool in FIG. 4 from another viewing angle;

FIG. 7 is a sectional view along A-A of the structural view of the handheld power tool in FIG. 2 from the another viewing angle;

FIG. 8 is a partial structural view of an internal structure of a handheld power tool according to an embodiment of the present disclosure;

FIG. 9 is a schematic half-sectional view of the partial structural view of the internal structure of the handheld power tool in FIG. 8;

FIG. 10 is an exploded view of a partial structure of a handheld power tool according to an embodiment of the present disclosure, where an output shaft is at a first position;

FIG. 11 is an exploded view of a partial structure of a handheld power tool according to an embodiment of the present disclosure, where an output shaft is at a second position;

FIG. 12 is a sectional view of a clamping portion of a handheld power tool according to an embodiment of the present disclosure;

FIG. 13A is a structural view of a handheld power tool according to an embodiment of the present disclosure, where an output shaft is at a first position;

FIG. 13B is a structural view of a handheld power tool from another viewing angle according to an embodiment of the present disclosure, where an output shaft is at a first position;

FIG. 14 is a structural view of a handheld power tool from another viewing angle according to an embodiment of the present disclosure, where an output shaft is at a second position;

FIG. 15 is an internal structural view of an output transmission assembly of a handheld power tool according to an embodiment of the present disclosure;

FIG. 16 is an exploded view of a partial structure of a handheld power tool according to an embodiment of the present disclosure;

FIG. 17 is a structural view of a handheld power tool according to an embodiment of the present disclosure, where an output shaft is at a first position;

FIG. 18 is a structural view of a handheld power tool from another viewing angle according to an embodiment of the present disclosure, where an output shaft is at a second position;

FIG. 19 is a half-sectional view of a partial structure of a handheld power tool according to an embodiment of the present disclosure; and

FIG. 20 is an exploded view of a partial structure of a handheld power tool according to an embodiment of the present disclosure.

### DETAILED DESCRIPTION OF THE EMBODIMENTS

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate member and the two members or assemblies are connected by the at least one intermediate member. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

To clearly illustrate the technical solutions of the present disclosure, an upper side, a lower side, a left side, a right side, a front side, and a rear side are defined in accompanying drawings of the specification.

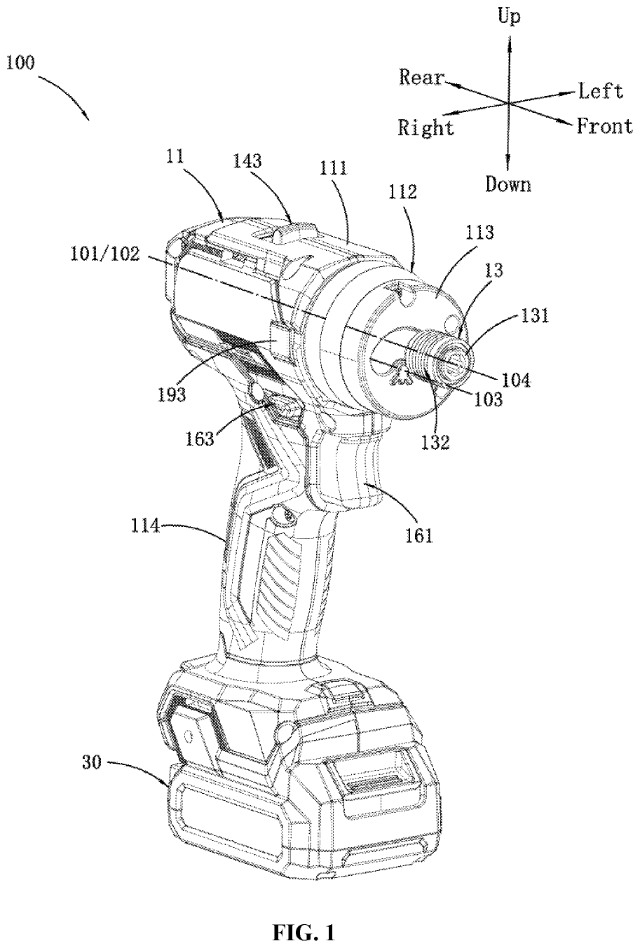

As shown in FIG. 1, a handheld power tool is provided. In this embodiment, the handheld power tool is an electric drill 100. In some embodiments, the handheld power tool may also be other handheld tools, such as an impact wrench, an impact screwdriver, a screwdriver, an impact drill, an electric hammer, an angle grinder, or an angular tool. In some embodiments, the handheld power tool is a tool that rotates to output power. In some embodiments, the handheld power tool is a tool that rotates to fasten or loosen a fastener.

FIG. 1 takes the electric drill 100 as an example. The electric drill 100 includes a power supply 30. In this embodiment, the power supply 30 is a direct-current (DC) power supply. The DC power supply provides electrical energy to the electric drill 100. The DC power supply is a battery pack. The battery pack cooperates with a corresponding power circuit to supply power to the electric drill 100. It should be understood by those skilled in the art that the power supply is not limited to the DC power supply, and may also be a mains power supply or an alternating-current (AC) power supply that supplies power to corresponding components in the machine in cooperation with corresponding rectification, filtering and voltage regulation circuits. In the following description, the battery pack 30 is used instead of the power supply, but this should not constitute a limitation to the present disclosure.

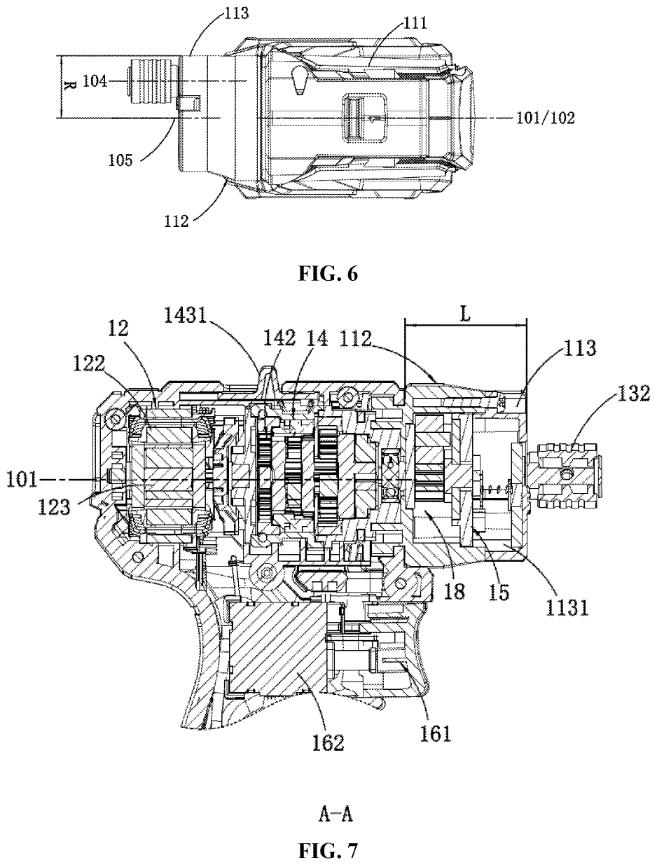

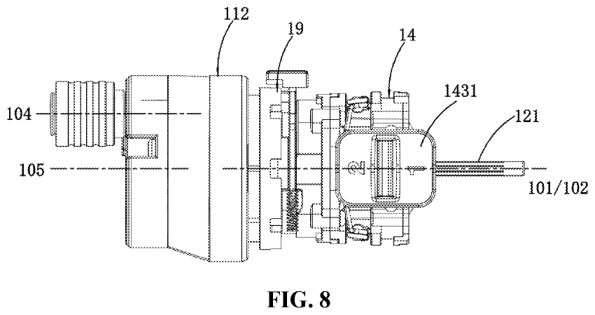

As shown in FIGS. 1 to 9, the electric drill 100 includes a housing 11, a motor 12, an output assembly 13, and a transmission mechanism 14. The motor 12 includes a drive shaft 121 rotating about a first axis 101. In this embodiment, the motor 12 is specifically an electric motor. Hereinafter, the electric motor 12 will be used instead of the motor, but this should not constitute a limitation to the present disclosure. In this embodiment, the electric motor 12 includes a stator assembly 122 and a rotor assembly 123. The rotor assembly 123 is provided with or connected to the drive shaft 121 rotating about the first axis 101. In this embodiment, the electric motor 12 is an inner-rotor brushless electric motor. In other alternative embodiments, the electric motor 12 is an outer-rotor brushless electric motor. For the inner-rotor brushless electric motor, the stator assembly 122 is sleeved on an outer side of the rotor assembly 123. For the outer-rotor brushless electric motor, the rotor assembly 123 is sleeved on an outer side of the stator assembly 122. In this embodiment, the brushless electric motor is a three-phase brushless electric motor. It is to be understood that the electric motor is not limited to the three-phase brushless electric motor, and may also be other types of DC electric motors. This should not affect the substantial content of the present disclosure.

As shown in FIG. 1, the housing 11 includes a drive housing 111 accommodating the electric motor and a second housing 112 accommodating at least a part of the output assembly 13. The second housing 112 is connected to a front end of the drive housing 111. In this embodiment, the housing 11 is further provided with or connected to a grip portion 114 for allowing a user to operate, facilitating gripping and operation by the user. One end of the grip portion 114 is connected to the battery pack 30.

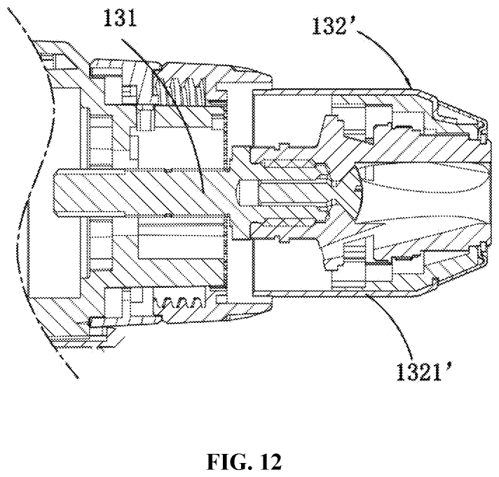

The output assembly 13 is configured to drive a working attachment to implement a function of the handheld power tool. In this embodiment, the output assembly 13 includes an output shaft 131. The output shaft 131 is configured to output power. The output shaft 131 rotates about an output axis 104. A front end of the output shaft 131 is provided with a clamping portion 132, which can clamp corresponding working attachments, such as a drill bit, a screwdriver, and a sleeve, when different functions are implemented. Optionally, the clamping portion 132 is a quick-detachable clamping component. As shown in FIG. 12, in some embodiments, when the handheld power tool is another type of drill, the clamping portion 132′ on the front end of the output shaft 131 is a multi-jaw chuck structure. For those skilled in the art, both the clamping portion 132 and the clamping portion 132′ are conventional structures in nature. Therefore, in the present disclosure, their detailed descriptions are omitted for the sake of brevity, and no specific limitation is imposed on them.

As shown in FIGS. 7 to 9, the transmission mechanism 14, such as a high-speed large-torque output tool like a screwdriver and a drill, is connected between the output assembly 13 and the electric motor 12. The transmission mechanism 14 is configured to connect the drive shaft 121 and the output shaft 131. The transmission mechanism 14 includes a transmission shaft 141 defining a second axis 102. The transmission shaft 141 is connected to the output shaft 131. In this embodiment, the transmission mechanism 14 is a reduction gear system. Optionally, the transmission mechanism 14 includes a planetary gear set 142 configured for speed reduction. The planetary gear set 142 may include one stage or a plurality of stages. The planetary gear set 142 converts an output rotational speed of the electric motor 12 according to a certain transmission ratio to obtain appropriate torque. In this embodiment, the drive shaft 121 is provided with or connected to a sun gear. A planetary gear is engaged with the sun gear. The transmission shaft 141 is disposed on a planetary carrier closest to the output shaft 131. It is to be understood that the transmission shaft 141 serves as torque output end of the transmission mechanism 14, and the torque or speed on the transmission shaft 141 is the final torque or speed of the drive shaft 121 upon speed reduction and torque increase of the transmission mechanism 14.

In some alternative embodiments, the transmission mechanism 14 further includes an impact assembly that applies an impact force to the output shaft 131, such as an impact wrench, an impact drill, or an electric hammer. Optionally, the transmission shaft 141 serves as an impact force output shaft of the impact assembly at this time, i.e., the transmission shaft 141 serves as an impact force output end of the transmission mechanism 14.

In this embodiment, the first axis 101 coincides with the second axis 102. In other alternative embodiments, an included angle is formed between the second axis 102 and the first axis 101. In other alternative embodiments, the second axis 102 is parallel to but does not coincide with the output axis 104.

The transmission mechanism 14 further includes a shift assembly 143 that is configured to switch gear sets having different transmission ratios to achieve multi-speed output. Since working principles of the speed reduction of the planetary gear and the speed reduction generated by the transmission mechanism 14 are fully disclosed to those skilled in the art, their detailed descriptions are omitted herein for the sake of brevity of the specification.

The shift assembly 143 includes a speed adjustment knob 1431. The speed adjustment knob 1431 is disposed on the drive housing 111 or the second housing 112. By toggling the speed adjustment knob 1431, the gear sets having the different transmission ratios can be switched to achieve the multi-speed output.

As shown in FIGS. 1 to 7, the electric drill 100 further includes a main switch 161 and a switching portion 163. The main switch 161 is a trigger switch. The trigger switch is disposed on the grip portion 114 to allow the user to operate. The rotational speed of the electric motor 12 is adjusted according to a trigger travel of the trigger switch. In this embodiment, the trigger switch is coupled to a sliding rheostat 162, and different trigger travels of the trigger switch result in different analog signals output by the sliding rheostat 162. The trigger travel of the trigger switch is positively correlated with a duty cycle of a pulse width modulation (PWM) signal of the electric motor 12, and the duty cycle of the PWM signal is positively correlated with the rotational speed of the electric motor 12. When the trigger travel of the trigger switch is small, the duty cycle of the PWM signal is also small, and thus the rotational speed of the electric motor 12 is low. In some embodiments, a mapping relationship between the trigger travel of the trigger switch and the duty cycle of the PWM signal is stored in the impact wrench. The mapping relationship may be linear or non-linear, which is not limited in this embodiment of the present disclosure.

The switching portion 163 is disposed on an upper side of the trigger switch. The switching portion 163 is configured to be operated to set a rotation direction of the motor as a forward direction for fastening a fastener or a reverse direction for loosening the fastener.

In this embodiment, the second housing 112 includes an output housing 113 that is configured to support rotation of the output shaft 131. As shown in FIGS. 7 to 9, the output housing 113 is provided with an accommodating portion 1131. A first bearing 115 that supports rotation of the output shaft 131 about the output axis 104 is sleeved on the output shaft 131. The accommodating portion 1131 is configured to mount the first bearing 115. Optionally, the first bearing 115 is a ball bearing. An inner race of the ball bearing is connected to the output shaft 131. It is to be understood that when the electric motor 12 starts to output power through the drive shaft 121, the output shaft 131 rotates relative to the output housing 113 about the output axis 104, so as to operate the fastener. Optionally, the first bearing 115 further includes a slide bearing, such as an oil bearing. In some embodiments, as shown in FIG. 12, for example, in the drill, the clamping portion 132′ is also provided with a housing 1321′. In this embodiment, the housing of the clamping portion 132′ does not constitute the output housing 113.

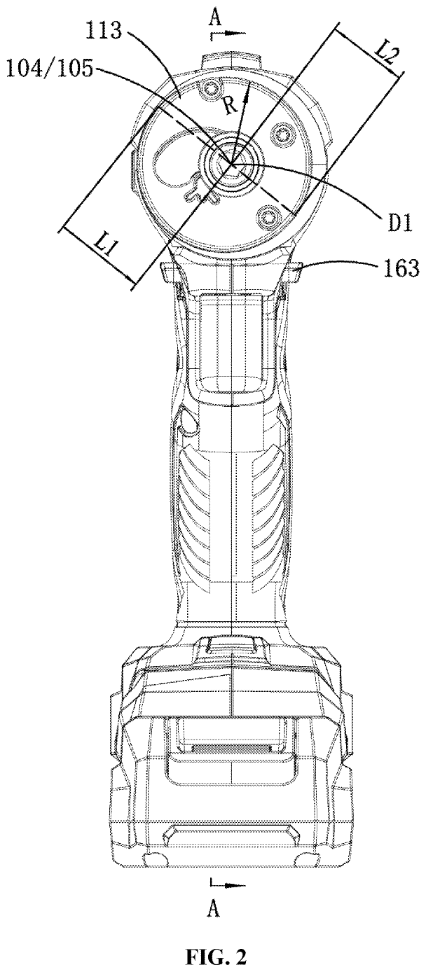

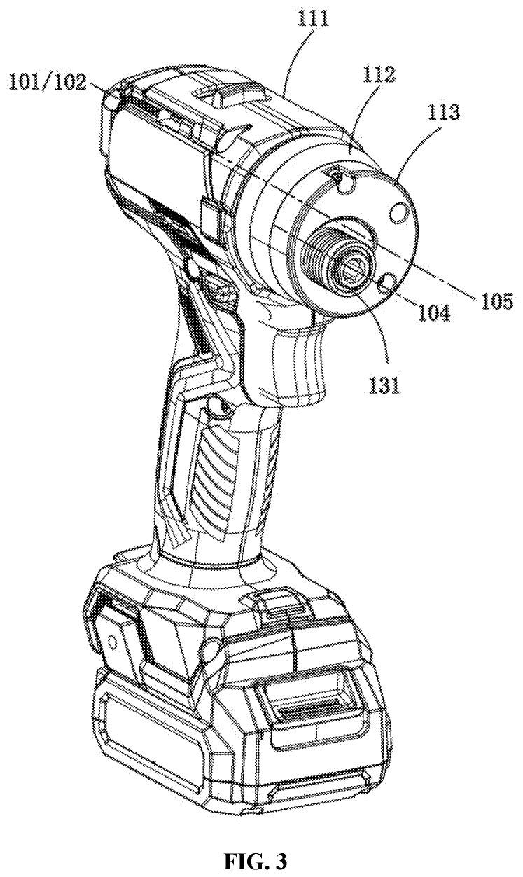

The electric drill 100 includes a first state in which the output axis 104 is substantially coaxial with the second axis 102, as shown in FIGS. 1 to 2, and a second state in which the output axis 104 is radially offset from the second axis 102, as shown in FIGS. 3 to 5. As shown in FIGS. 1 to 2, the first state may be understood as a “central” state of the output shaft 131, i.e., a working condition of an ordinary fastening-type handheld power tool. As shown in FIGS. 3 to 5, the second state may be understood as an offset “edge-following” state of the output shaft 131.

As shown in FIGS. 1 to 4, the output shaft 131 moves relative to the output housing 113, such that the output shaft 131 is radially offset relative to the first central axis 105. It is to be understood that each movement of the output shaft 131 relative to the output housing 113 has a stop point, and each stop point is offset relative to another stop point along a radial direction of the first central axis 105. The electric drill 100 achieves the first state and the second state through the movement of the output shaft 131 relative to the output housing 113. In the related art, the handheld fastening tool capable of achieving an offset edge-following function of the output shaft 131 generally implements the edge-following function by providing an attachment on the output shaft 131. An output shaft of the attachment is eccentric to the output shaft 131 of the machine, i.e., an output axis of the attachment is radially offset from the output axis 104 of the machine. When offset edge following of the output shaft 131 is needed, the attachment is disposed on the machine. With such a structure, the user needs to carry the attachment additionally during work and to repeatedly disassemble and assemble the working attachment (such as a bit) on the attachment and the machine body to adapt to the edge-following condition and non-edge-following condition, which is detrimental to working efficiency.

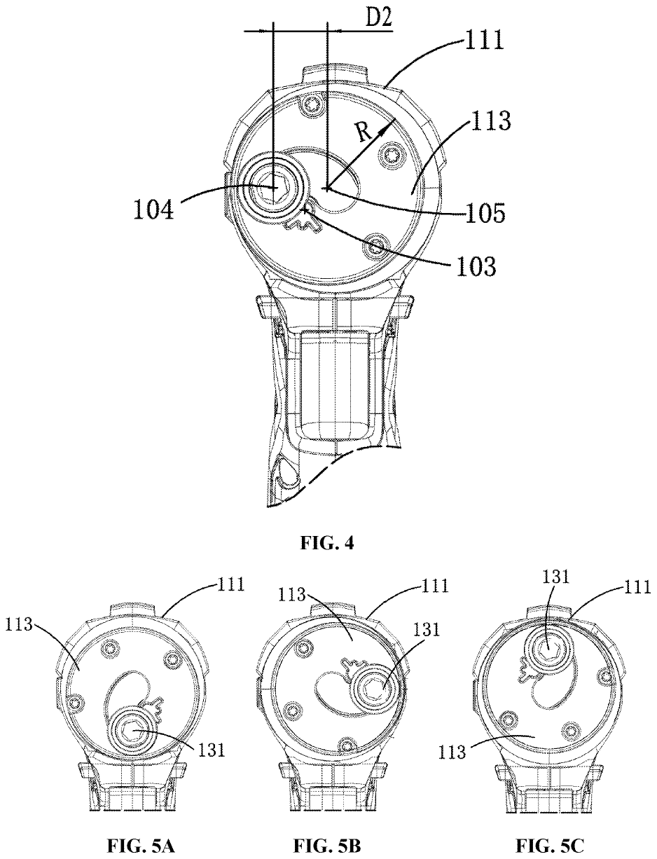

In this embodiment, the output shaft 131 moves relative to the output housing 113 along the radial direction of the first central axis 105. That is, the output shaft 131 includes a first position as shown in FIG. 2 and a second position as shown in FIG. 4. At the first position, a radial distance from the output axis 104 to the first central axis 105 is D1. At the second position, the radial distance from the output axis 104 to the first central axis 105 is D2. D1 is less than D2. When a radial distance from the first central axis 105 to an outer edge of the output housing 113 is defined as R, D1 is greater than or equal to 0 and less than R, and D2 is greater than 0 and less than or equal to R. Hence, when the output shaft 131 is at the first position, the electric drill 100 is in the first state. When the output shaft 131 is at the second position, the electric drill 100 is in the second state. The movement of the output axis 104 forms an arc trajectory when the output axis 104 moves from the first position to the second position. It should be understood that the number of the arc trajectory could be more than one. That is to say, there could be two arc trajectories in one handheld power tool. There could also be three or more arc trajectories in one handheld power tool. When there are more than one arc trajectories in one handheld power tool, a plurality of second positions exist in that handheld power tool.

According to the above definition of the output housing 113, the output housing 113 is configured to support rotation of the output shaft 131. In this embodiment, the output housing 113 accommodates the first bearing 115. Optionally, projection of the output housing 113 along a front-rear direction is substantially circular or quasi-circular. The output housing 113 is provided with the first central axis 105 passing through a geometric center. Optionally, the geometric center is a center of the output housing 113, and the first central axis 105 is a central axis of the output housing 113. As shown in FIGS. 2, 4 and 6, the radial distance from the first central axis 105 to the outer edge of the output housing 113 is R, where R is a radius of the output housing 113 or a radius of a projection plane of the output housing 113 along the front-rear direction. In some alternative embodiments, the output housing 113 is polygonal, and the first central axis is a straight line extending along the front-rear direction through the geometric center. If the radial distance from the first central axis 105 to the outer edge of the output housing 113 is the R, the R is unnecessarily a fixed value. The above does not affect the substantial content of the present disclosure.

By providing the output shaft 131 that can move radially relative to the output housing 113, the conventional central form and the offset form of the output shaft 131 relative to the center can be realized without the attachment. Only by adjusting the position of the output shaft 131, the user can switch two states conveniently, thereby improving the working efficiency. Without carrying the additional attachment, the user experience is improved.

Through the output shaft 131 that can move relative to the output housing 113 or radially move relative to the first central axis 105, the output shaft 131 can be adjusted more flexibly relative to the first central axis 105 within a range from 0 to R.

In some alternative embodiments, the first position and the second position of the output shaft 131 correspond to two different offset edge-following states of the output shaft 131. At this time, it is to be understood that when the output shaft 131 is at the first position and the second position, the electric drill 100 is in the second state. In this case, the output shaft 131 may be an output shaft of the attachment, and the output housing 113 may be the housing of the attachment. This enables one attachment to achieve a plurality of offset edge-following sizes and to be applied to a variety of edge-following conditions. The output shaft can be adjusted more flexibly relative to the first central axis 105 within the range from 0 to R. Therefore, when the first position and the second position of the output shaft 131 correspond to two different edge-following states, the solution is also applied to products with the attachment, which can likewise improve the working efficiency.

In this embodiment, the first central axis 105 coincides with the second axis 102. In other alternative embodiments, the first central axis 105 is parallel to but does not coincide with the second axis 102. In other alternative embodiments, an included angle is formed between the first central axis 105 and the second axis 102.

Optionally, the output shaft 131 rotates relative to the output housing 113 about the third axis 103, i.e., the output shaft 131 is switched between the first position (as shown in FIG. 1) and the second position (as shown in FIG. 3) through rotation about the third axis 103. The third axis 103 is parallel to but offset from the first central axis 105. Optionally, the third axis 103 is disposed between the first position of the output shaft 131 and the second position of the output shaft 131. Certainly, in other alternative embodiments, the first position and the second position can be switched via radial translation or rotation relative to other reference axes.

As shown in FIGS. 1 to 2, in the first state in which the output axis 104 is substantially coaxial with the second axis 102, radial distances from the output axis 104 to outer edges at two sides of the output housing 113 in a same radial direction are respectively L1 and L2, a ratio of L1 to L2 being greater than or equal to 0.4 and less than or equal to 1. In some embodiments, the ratio of L1 to L2 is greater than or equal to 0.5 and less than or equal to 1. In some embodiments, the ratio of L1 to L2 is greater than or equal to 0.6 and less than or equal to 1. In some embodiments, the ratio of L1 to L2 is greater than or equal to 0.7 and less than or equal to 1. In some embodiments, the ratio of L1 to L2 is greater than or equal to 0.8 and less than or equal to 1. L1 is less than or equal to L2. In this embodiment of the present disclosure, when the electric drill 100 is in the first state, the position of the output shaft 131 is substantially the same as that of a conventional electric drill or a tool for rotationally outputting torque. That is, when the electric drill 100 is in the first state, the electric drill 100 can follow the use habit and appearance of a conventional screwdriver. Since the output shaft 131 of the conventional electric drill (i.e., the electric drill 100 without the edge-following function) is substantially located at a center of the output housing 113, in the first state in which the output axis 104 is substantially coaxial with the second axis 102, the output axis 104 is substantially coaxial with the first central axis 105. It is to be understood that when the output shaft 131 is at the first position, D1 is substantially 0. It is to be understood that for some conventional electric drills, the ratio of the radial distances from the output axis of the output shaft to the outer edges on the two sides of the output housing in the same radial direction, i.e., L1/L2, is not equal to 1. For such electric drills having the output shaft offset function, when the output shaft is at the first position, the ratio L1/L2 is not equal to 1. For example, the ratio L1/L2 is greater than or equal to 0.4 and less than 1.

In this embodiment, since the output shaft 131 can move relative to the output housing 113, the output shaft 131 can be offset relative to the first central axis 105 of the output housing 113, and can also return to the center of the output housing 113 or a position relatively close to the center. This can keep the appearance and use habit of the conventional screwdriver in the related art, and can also reduce the shaking of the output shaft 131 in the first state.

In this embodiment, when the electric drill 100 is in the second state, according to the above description, the output shaft 131 is displaced radially to the second position relative to the output housing 113 about the third axis 103.

As shown in FIG. 4 to FIGS. 5A-5C, to offset the electric drill 100 in a plurality of directions, in this embodiment, when the output shaft 131 is at the second position, the output shaft 131 rotates relative to the drive housing 111 about the first central axis 105. Thus, the output shaft 131 is offset in the plurality of directions. Optionally, the output housing 113 rotates relative to the drive housing 111 about the first central axis 105, and the output shaft 131 rotates synchronously with the output housing 113. Optionally, the output housing 113 may partially rotate about the first central axis 105 to drive the output shaft 131 to rotate synchronously. In this embodiment, since the output housing 113 may rotate about the first central axis 105, when the output shaft 131 is at the first position, the output shaft 131 may also be driven by the output housing 113 to rotate about the first central axis 105. In this embodiment, the second housing 112 and the output housing 113 do not move relative to each other, i.e., the second housing 112 rotates synchronously with the output housing 113. Optionally, the second housing 112 rotates relative to the drive housing 111 about the first central axis 105, and the output shaft 131 rotates synchronously with the second housing 112. Optionally, the second housing 112 may partially rotate about the first central axis 105 to drive the output shaft 131 to rotate synchronously. It is to be noted that in this embodiment, the second housing 112 and the output housing 113 rotate synchronously or are integrally formed. However, due to shaping requirements or other functional requirements, a geometric center of the output housing is not the same as a geometric center of the second housing. In some embodiments, the second housing 112 and the output housing 113 have a same shape, and thus may have a same geometric center. In some embodiments, the handheld power tool may further include a structure that can rotationally adjust torque or output a rotational speed. Since rotation of such a component does not change the position of the output axis relative to the second axis, such a rotating component does not constitute the second housing.

Since the output shaft 131 must be stably connected and driven during operation (i.e., when it outputs power), the electric drill 100 further includes a first locking portion 151 that is configured to retain the output shaft 131 at the first position or the second position, and a second locking assembly 19 that is configured to selectively lock rotation of the output housing 113 relative to the drive housing 111. Specific structures of the first locking portion 151 and the second locking assembly 19 will be described in detail below.

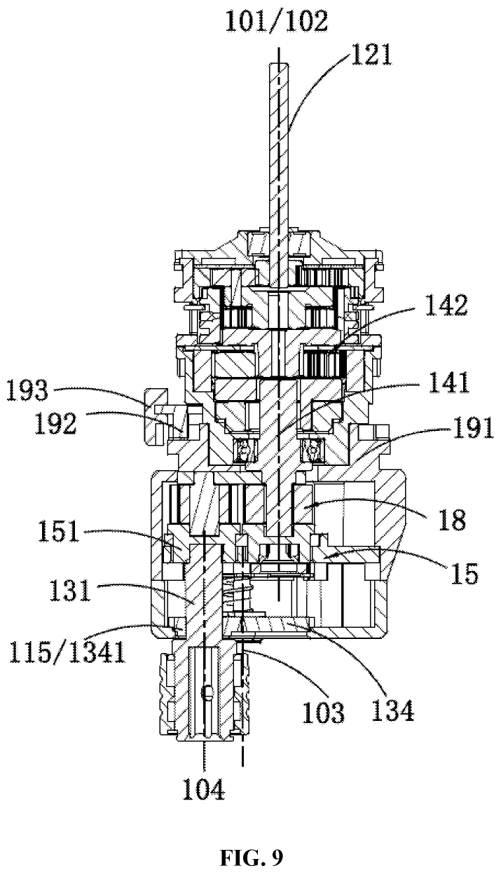

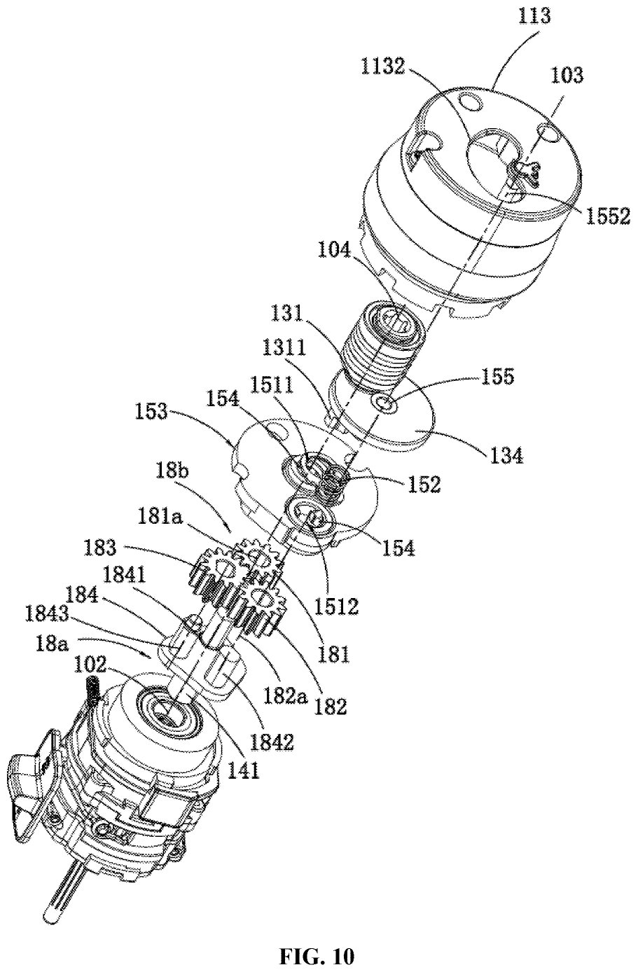

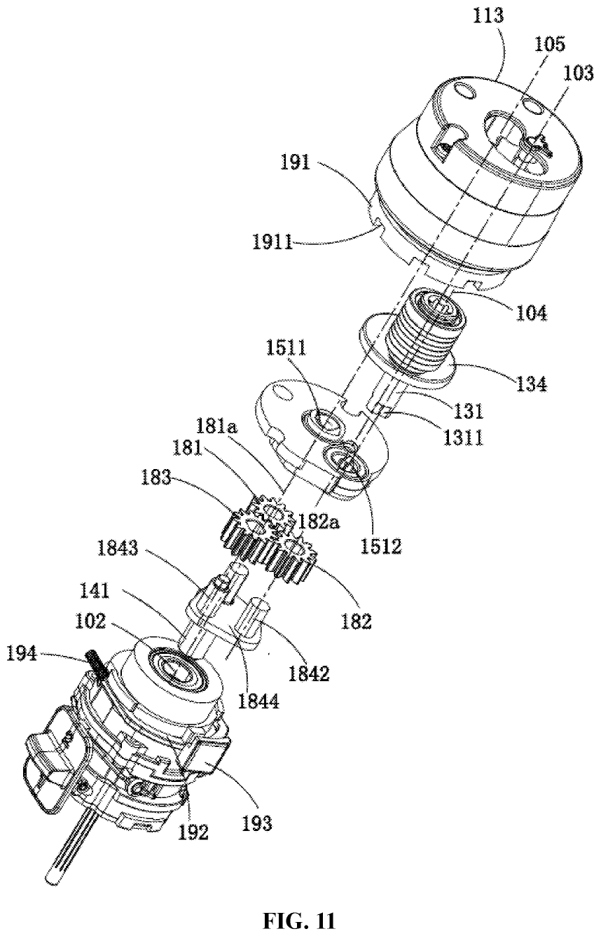

As shown in FIGS. 7 to 11, the electric drill 100 further includes a clutch assembly 15 that is disposed between the transmission shaft 141 and the output shaft 131. The clutch assembly 15 includes an engaged state for torque transmission between the transmission shaft 141 and the output shaft 131 and a disengaged state for transmission interruption between the transmission shaft 141 and the output shaft 131. When the clutch assembly 15 is in the disengaged state, the output shaft 131 is allowed to move in a direction perpendicular to the first axis 101. Optionally, when the clutch assembly 15 is in the disengaged state, the output shaft 131 is allowed to move radially relative to the output housing 113. With the clutch assembly 15, the output shaft 131 can be switched between the first position and the second position, and the power can be transmitted from the electric motor to the output shaft 131 at the first position or the second position. As shown in FIGS. 9 and 11, the output shaft is at the second position. As shown in FIG. 10, the output shaft is at the first position.

With the disengaged state of the clutch assembly 15, the output shaft 131 can displace radially to achieve the offset function. With the engaged state, the output shaft 131 can ensure a power transmission path upon the radial displacement, thereby ensuring the service function of the electric drill 100.

The electric drill 100 further includes an output transmission assembly 18 that is disposed between the transmission shaft 141 and the output shaft 131. As shown in FIG. 10, the output transmission assembly 18 includes an input portion 18a connected to the transmission shaft 141 and an output portion 18b connected to the output shaft 131. As shown in FIGS. 10 and 11, the output portion 18b includes a first transmission gear 181 and a second transmission gear 182. The output shaft 131 is selectively coupled to the first transmission gear 181 or the second transmission gear 182, to transmit power of the transmission shaft 141 to the output shaft 131. Since the output shaft 131 is selectively coupled to the first transmission gear 181 or the second transmission gear 182, not only can the output shaft 131 displace radially to achieve the offset function, but also the output shaft 131 can ensure the power transmission path after the radial displacement, thereby ensuring the service function of the electric drill 100.

In this embodiment, the output transmission assembly 18 is connected to the clutch assembly 15. It is to be noted that the transmission shaft 141, the output transmission assembly 18, the clutch assembly 15, and the output shaft 131 may share a part of structures. Meanwhile, the output transmission assembly 18 and the clutch assembly 15 can be selectively provided according to actual requirements of different products.

As shown in FIGS. 9 to 10, the clutch assembly 15 includes the first locking portion 151 and a restoring member 152. The first locking portion 151 is configured to retain the output shaft 131 at the first position or the second position. The first locking portion 151 includes a first limiting portion 1511 corresponding to the first position and a second limiting portion 1512 corresponding to the second position. The output shaft 131 is selectively connected to the first limiting portion 1511 or the second limiting portion 1512 at a corresponding position. Optionally, the first limiting portion 1511 corresponds to the output shaft 131 at the first position, and the second limiting portion 1512 corresponds to the output shaft 131 at the second position. The first limiting portion 1511 and the second limiting portion 1512 are disposed on or connected to a first mounting frame 153. Optionally, the first limiting portion 1511 includes a limiting tooth 154, and the second limiting portion 1512 includes a limiting tooth 154 same as that of the first limiting portion 1511. A rear end of the output shaft 131 is provided with or connected to a limiting tooth slot 1311 matching with the limiting tooth 154. When the output shaft 131 is connected to the first limiting portion 1511 or the second limiting portion 1512, the limiting tooth slot 1311 is connected to the limiting tooth 154 to limit rotation of the output shaft 131 relative to the first limiting portion 1511 or the second limiting portion 1512. It is to be understood that the limiting tooth and the limiting tooth slot are positionally interchangeable, which does not affect the substantial content of the present disclosure. In some embodiments, the output shaft and the limiting portion may further cooperate through other mechanical cooperation structures, to realize circumferential limitation of the limiting portion on the output shaft. In some embodiments, the output shaft and the limiting portion may further cooperate electromagnetically, to realize circumferential limitation of the limiting portion on the output shaft.

To switch the position of the output shaft 131 relative to the output housing 113, a first mounting portion 134 is disposed on or connected to the output shaft 131. A first connecting portion 155 coaxial with the third axis 103 is disposed on the first mounting frame 153. To enable the output shaft 131 to switch between the first position and the second position by rotating about the third axis 103, the first connecting portion 155 is connected to the first mounting frame 153 through a first shaft 1552. The first shaft 1552 is coaxial with the third axis 103. Optionally, the first shaft 1552 is disposed in the output housing 113. With the first shaft 1552, the first mounting portion 134 is rotatably connected to the first mounting frame 153, i.e., the output shaft 131 is rotatably connected to the first mounting frame 153, such that the output shaft 131 is connected to the first limiting portion 1511 or the second limiting portion 1512. Optionally, the first shaft 1552 is connected between the first limiting portion 1511 and the second limiting portion 1512.

The restoring member 152 is configured to drive the clutch assembly 15 to switch from the disengaged state to the engaged state. Optionally, when the output shaft 131 is disengaged from the first limiting portion 1511 or the second limiting portion 1512, the restoring member 152 applies a force that pushes the output shaft 131 close to the first limiting portion 1511 or the second limiting portion 1512. In this embodiment, the restoring member 152 could be a spiral spring. Optionally, the restoring member 152 is a biasing member or a compression spring. Optionally, to stably fix the restoring member 152, the restoring member 152 includes one end connected to the output shaft 131, and another end connected to the clutch assembly 15. Optionally, the restoring member 152 includes one end connected to the first mounting portion 134, and another end connected to the first mounting frame 153. Meanwhile, to prevent the restoring member 152 from twisting, the restoring member 152 is sleeved on the first shaft 1552.

Taking the switching of the output shaft 131 from the first position (as shown in FIG. 10) to the second position (as shown in FIGS. 9 and 11) as an example, when the output shaft 131 is at the first position, the limiting tooth slot 1311 in the output shaft 131 is engaged with the limiting tooth 154 of the first limiting portion 1511, i.e., the output shaft 131 is retained in the first limiting portion 1511. At this time, the restoring member 152 is in an unloaded state, or applies a force to the output shaft 131 toward the first limiting portion 1511, to achieve more stable axial cooperation between the output shaft 131 and the first limiting portion 1511. The output shaft 131 moves away from the first limiting portion 1511 through an external force. In this embodiment, to apply an axial and forward force to the output shaft 131 to disengage the output shaft 131 from the first limiting portion 1511, in this embodiment, the output shaft is pulled forward. In this case, the restoring member 152 is compressed to store energy. Through the external force, the output shaft 131 rotates around the third axis 103, thereby switching from the first position to the second position. The output shaft 131 moves to a position substantially aligned with the second limiting portion 1512. After the external force is withdrawn, the restoring member 152 releases the energy to drive the output shaft 131 toward the second limiting portion 1512, such that the output shaft 131 enters the second limiting portion 1512, and the limiting tooth slot 1311 is engaged with the limiting tooth 154 of the second limiting portion 1512, thereby switching the output shaft 131.

In this embodiment, as shown in FIG. 10, a displacement limiting groove 1132 is formed in the output housing 113. The displacement limiting groove 1132 is configured to indicate the first position and the second position of the output shaft 131, such that the output shaft 131 can be more accurately aligned with the first limiting portion 1511 or the second limiting portion 1512.

As shown in FIG. 9, the first mounting portion 134 includes a bearing seat 1341 that accommodates the first bearing 115. The first mounting portion 134 is accommodated in the accommodating portion 1131 of the output housing 113.

For the output transmission assembly 18, the first transmission gear 181 is in transmission connection with the first limiting portion 1511, and the second transmission gear 182 is in transmission connection with the second limiting portion 1512. Optionally, an axis of the first transmission gear 181 drives the first limiting portion 1511, while an axis 1842 of the second transmission gear 182 drives the second limiting portion 1512. Optionally, when the output shaft 131 is at the first position, the output shaft 131 is coupled to the first transmission gear 181. Optionally, when the output shaft 131 is at the second position, the output shaft 131 is coupled to the second transmission gear 182.

In this embodiment, since the output axis 104 is substantially coaxial with the second axis 102 when the output shaft 131 is at the first position, the first transmission gear 181 is coaxially coupled to the transmission shaft 141. Optionally, the transmission shaft 141 directly drives the first transmission gear 181, i.e., the transmission shaft 141 serves as the axis of the first transmission gear 181, and the axis 181a of the first transmission gear 181 serves as the second axis 102. Optionally, the output transmission assembly 18 includes a gear carrier 184. The gear carrier 184 is configured to support a transmission gear. In this embodiment, the gear carrier 184 is provided with an axis in the form of a cantilever. A shaft hole 1841 is formed in the first transmission gear 181, such that the transmission shaft 141 passes through the gear carrier 184 and is connected to the first transmission gear 181. In other alternative embodiments, the first transmission gear 181 is connected to the gear carrier 184 through an axis and then connected to the transmission shaft 141. The second transmission gear 182 is connected to the gear carrier 184 through the axis 1842. Both the first transmission gear 181 and the second transmission gear 182 are disposed on a first plane 1844 of the gear carrier 184. An axis 181a of the first transmission gear 181 is substantially parallel to an axis 182a of the second transmission gear 182. The first transmission gear 181 and the second transmission gear 182 have a same rotation direction, such that the output shaft 131 has a same rotation direction at the first position and the second position. Hence, the output shaft 18b further includes a third transmission gear 183. The third transmission gear 183 is in transmission connection with the first transmission gear 181 and the second transmission gear 182.

After the electric motor 12 drives the drive shaft 121 to rotate, the first transmission gear 181 is driven by the transmission shaft 141 of the transmission mechanism 14. The first transmission gear 181 drives the second transmission gear 182 through the third transmission gear 183. The second transmission gear 182 and the first transmission gear 181 moves in a same direction. In this embodiment, the first transmission gear 181, the third transmission gear 183, and the second transmission gear 182 are cylindrical gears and externally engaged. Optionally, the first transmission gear 181, the third transmission gear 183, and the second transmission gear 182 are in transmission connection at a transmission ratio of 1:1. Optionally, a transmission ratio between the first transmission gear 181 and the third transmission gear 183 is less than 1, while a transmission ratio between the third transmission gear and the second transmission gear is greater than 1, thereby ensuring that the first transmission gear 181 and the second transmission gear 182 have a substantially same rotational speed. That is, the first transmission gear 181 and the second transmission gear 182 are in transmission connection at a transmission ratio of 1:1 as a whole.

In this embodiment, an axis 1843 of the third transmission gear 183 is parallel to but does not coincide with the third axis 103. In other alternative embodiments, the axis 1843 of the third transmission gear 183 is coaxial with the third axis 103.

As shown in FIGS. 7 to 9, the output transmission assembly 18 and the clutch assembly 15 are at least partially accommodated in the second housing 112. The second housing 112 rotates relative to the drive housing 111. By rotating the second housing 112, a position of the output axis 104 relative to the second axis 102 is adjusted. In this embodiment, an axial length L from a rear end of the second housing 112 to an extended end of the output shaft 131 is less than or equal to 56 mm. In this embodiment, the clutch assembly 15 and the single-layer gear assembly are used to achieve position switching of the output shaft 131 and ensure the power transmission path. Therefore, the structure of the present disclosure for realizing the offset function of the output shaft 131 has a compact length. Compared with structures adopting two-stage or multi-stage offset gear transmission in the related art, the axial size is small and the product structure is compact. In some embodiments, the axial length L from the rear end of the second housing 112 to the extended end of the output shaft 131 is less than or equal to 50 mm. In some embodiments, the axial length L from the rear end of the second housing 112 to the extended end of the output shaft 131 is less than or equal to 51 mm, 52 mm, 53 mm, 54 mm, and 55 mm. In some embodiments, the axial length L from the rear end of the second housing 112 to the extended end of the output shaft 131 is less than or equal to 50 mm. In some embodiments, the axial length L from the rear end of the second housing 112 to the extended end of the output shaft 131 is less than or equal to 45 mm. In some embodiments, the axial length L from the rear end of the second housing 112 to the extended end of the output shaft 131 is less than or equal to 40 mm. In some embodiments, the axial length L from the rear end of the second housing 112 to the extended end of the output shaft 131 is less than or equal to 35 mm. In some embodiments, the axial length L from the rear end of the second housing 112 to the extended end of the output shaft 131 is less than or equal to 30 mm. In some embodiments, the axial length L from the rear end of the second housing 112 to the extended end of the output shaft 131 is less than or equal to 25 mm.

In this embodiment, the output transmission assembly 18 and the clutch assembly 15 are at least partially accommodated in the output housing 113. When the output housing 113 rotates about the first central axis 105, the output transmission assembly 18 and the clutch assembly 15 at least partially rotate with the output housing 113. Optionally, the first transmission gear 181 is coaxially connected to the transmission shaft 141. When the output housing 113 rotates, the output shaft 131 rotates relative to the drive housing 111 about the first central axis 105, and the second transmission gear 182 and the third transmission gear 183 rotate relative to the drive housing 111 about the first central axis 105. In some embodiments, due to shaping or other requirements, the output housing constitutes a part of the second housing. In some embodiments, when the second housing is of an integral structure, and the second housing serves as the output housing, an axial length L of the output housing 113 is less than or equal to 56 mm. In some embodiments, the axial length L of the output housing 113 is less than or equal to 50 mm. In some embodiments, the axial length L of the output housing 113 is less than or equal to 51 mm, 52 mm, 53 mm, 54 mm, and 55 mm. In some embodiments, the axial length L of the output housing 113 is less than or equal to 45 mm. In some embodiments, the axial length L of the output housing 113 is less than or equal to 40 mm. In some embodiments, the axial length L of the output housing 113 is less than or equal to 35 mm. In some embodiments, the axial length L of the output housing 113 is less than or equal to 30 mm. In some embodiments, the axial length L of the output housing 113 is less than or equal to 25 mm.

In some alternative embodiments, when the output transmission assembly 18 and the clutch assembly 15, or parts of the output transmission assembly 18 and the clutch assembly 15, are provided as detachable parts of the attachment to enable a plurality of offset sizes with one single attachment, the second housing or the output housing, or both the second housing and the output housing, form a housing of the attachment, or the second housing or the output housing, or both the second housing and the output housing, form a part of the housing of the attachment. In this embodiment, the axial length L from the rear end of the second housing to the extended end of the output shaft is less than or equal to 56 mm. In some embodiments, the axial length L from the rear end of the second housing to the extended end of the output shaft is less than or equal to 50 mm. In some embodiments, the axial length L from the rear end of the second housing to the extended end of the output shaft is less than or equal to 51 mm, 52 mm, 53 mm, 54 mm, and 55 mm. In some embodiments, the axial length L from the rear end of the second housing to the extended end of the output shaft is less than or equal to 50 mm. In some embodiments, the axial length L from the rear end of the second housing to the extended end of the output shaft is less than or equal to 45 mm. In some embodiments, the axial length L from the rear end of the second housing to the extended end of the output shaft is less than or equal to 40 mm. In some embodiments, the axial length L from the rear end of the second housing to the extended end of the output shaft is less than or equal to 35 mm. In some embodiments, the axial length L from the rear end of the second housing to the extended end of the output shaft is less than or equal to 30 mm. In some embodiments, the axial length L from the rear end of the second housing to the extended end of the output shaft is less than or equal to 25 mm.

As shown in FIG. 11, the second locking assembly 19 includes a locking toothed ring 191 and a sliding portion 192. One end of the sliding portion 192 is provided with or connected to an operating member 193. The operating member 193 is at least partially located on a visible surface and configured to be activated to operate. In this embodiment, the operating member 193 is disposed on the drive housing 111. When the second locking assembly 19 locks the rotation of the second housing 112 relative to the drive housing 111, the sliding portion 192 cooperates with a tooth portion of the locking toothed ring 191 to restrict the rotation of the second housing 112. Optionally, the sliding portion 192 is connected to the drive housing 111. The locking toothed ring 191 is disposed on the output housing 113. The locking toothed ring 191 rotates with the output housing 113. Optionally, the locking toothed ring 191 includes a plurality of tooth portions 1911, such that the output housing 113 has a plurality of locking positions, and the electric drill 100 can offset in a plurality of directions, thereby adapting to a wider range of working conditions. By driving the sliding portion 192 with an external force, the sliding portion 192 is disengaged from the tooth portion 1911 of the locking toothed ring 191, and the user can rotate the output housing 113. After the external force is withdrawn, the sliding portion 192 under a driving force of a driving portion 194 slides to the tooth portion 1911 or drives the locking toothed ring 191 to rotate to the tooth portion 1911 nearest to the sliding portion 192 to cooperate with the sliding portion 192. When the driving portion 194 applies the driving force, the sliding portion 192 cooperates with the tooth portion 1911 more stably to provide a sufficient locking force. Optionally, the driving portion 194 is a spring.

In some alternative embodiments, the operating member 193 may also not be provided. By rotating the output housing 113, the sliding portion 192 is driven to move, such that the sliding portion 192 is disengaged from the locking toothed ring 191, thereby implementing rotation of the output housing 113.

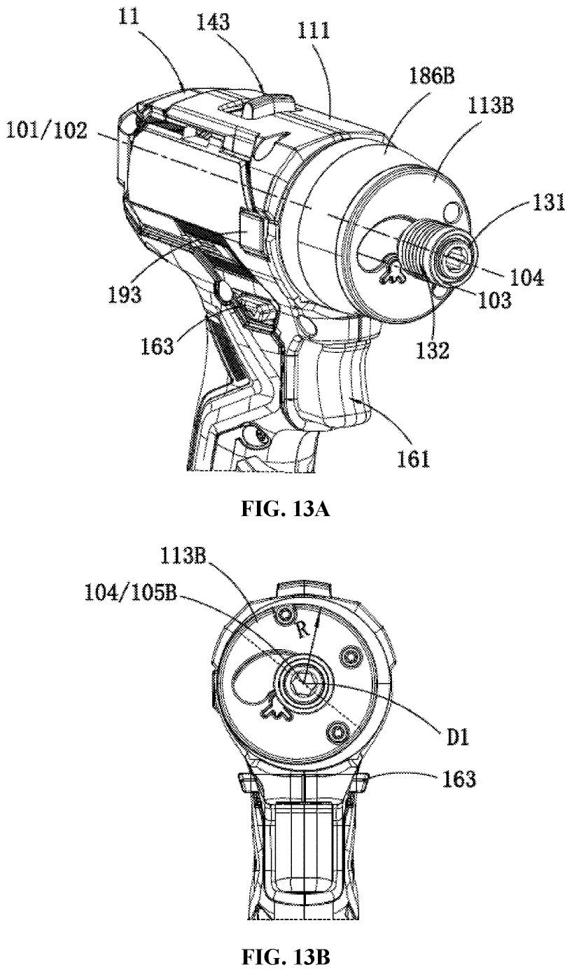

As shown in FIGS. 13A to 16, another embodiment of the present disclosure provides an electric drill. Features and elements corresponding to those of the electric drill 100 are denoted by similar reference numerals followed by the letter “B”. Identical features have same reference numerals. The following descriptions focus on differences between the embodiments.

Referring to FIG. 7, the handheld power tool includes: a motor 12 that includes a drive shaft 121 rotating about a first axis 101; a drive housing 111 that at least accommodates the motor 12; and an output shaft 131 that defines an output axis 104. The output shaft 131 rotates about the output axis 104 to output power.

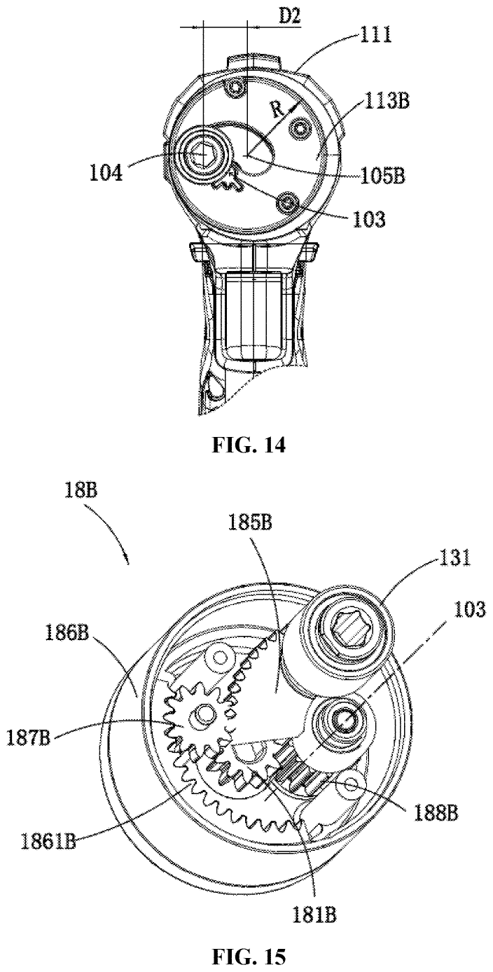

As shown in FIGS. 13A to 14, the handheld power tool further includes an output housing 113B that is configured to support rotation of the output shaft 131. The output housing 113B defines a first central axis 105B passing through a geometric center. The output shaft 131 includes a first position where a radial distance from the output axis 104 to the first central axis 105B is D1 and a second position where the radial distance from the output axis 104 to the first central axis 105B is D2. The output shaft 131 moves relative to the output housing 113B, such that the output shaft 131 is radially offset relative to the first central axis 105B It is to be understood that each movement of the output shaft 131 relative to the output housing 113B has a stop point, and each stop point is offset relative to another stop point along a radial direction of the first central axis 105B. Through movement of the output shaft 131 relative to the output housing 113B, the electric drill 100 achieves a first state (a “central” state of the output shaft 131) and a second state (an offset “edge-following” state of the output shaft 131). The output shaft 131 moves relative to the output housing 113B along the radial direction of the first central axis 105B, i.e., the output shaft 131 includes a first position as shown in FIGS. 13A and 13B and a second position as shown in FIG. 14. At the first position, a radial distance from the output axis 104 to the first central axis 105B is D1. At the second position, the radial distance from the output axis 104 to the first central axis 105B is D2. D1 is less than D2.

In this embodiment, the output axis 104 is substantially coaxial with the second axis 102 when the output shaft 131 is at the first position. The output axis 104 is radially offset from the second axis 102 when the output shaft 131 is at the second position.

In some alternative embodiments, the first position and the second position of the output shaft 131 correspond to two different offset edge-following states of the output shaft 131. At this time, it is to be understood that when the output shaft 131 is at the first position and the second position, the electric drill 100 is in the second state (the offset edge-following state of the output shaft 131).

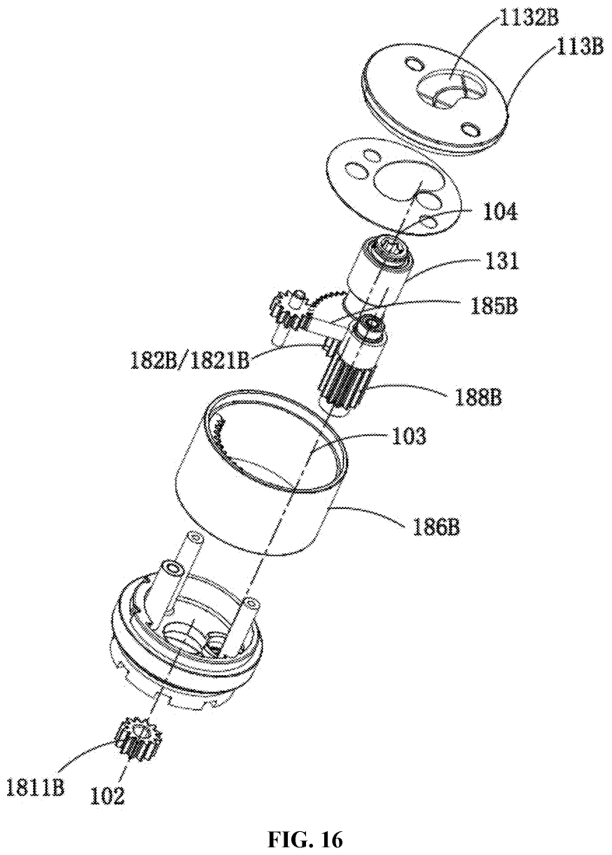

As shown in FIGS. 15 to 16, the handheld power tool further includes an output transmission assembly 18B that is disposed between the drive shaft and the output shaft 131. In this embodiment, a transmission mechanism 14 is disposed between the drive shaft and the output shaft of the handheld power tool. The transmission mechanism 14 is provided with a transmission shaft 141. The output transmission assembly 18B is disposed between the transmission shaft 141 and the output shaft 131. In other alternative embodiments, the drive shaft directly drives the output shaft. The output transmission assembly 18B may also be disposed between the drive shaft and the output shaft.

In this embodiment, the output transmission assembly 18B includes an input portion 181B that inputs power. Exemplarily, the input portion 181B is connected to the transmission shaft 141. The output transmission assembly 18B further includes an output portion 182B connected to the output shaft 131. The handheld power tool further includes a first intermediate gear 185B. The output shaft 131 is rotatably connected to the first intermediate gear 185B. The output shaft 131 rotates relative to the first intermediate gear 185B about the output axis 104. The first intermediate gear 185B is driven to rotate about a third axis 103, such that the output shaft 131 rotates about the third axis 103. In this embodiment, the output axis 104 is offset from the third axis 103.

The output shaft 131 rotates about the third axis 103 to switch between the first position and the second position. Optionally, the output shaft 131 rotates relative to the output housing 113B about the third axis 103 to switch between the first state and the second state. The output shaft 131 rotates relative to the output housing 113B about the output axis 104 to output power.

The output transmission assembly 18B includes a transmission housing 186B. The transmission housing 186B at least accommodates a part of the first intermediate gear 185B. By rotating the transmission housing 186B, the first intermediate gear 185B is driven to rotate about the third axis 103. Exemplarily, the transmission housing 186B is connected to the output housing 113B. The transmission housing 186B rotates relative to the output housing 113B to drive the first intermediate gear 185B. In this embodiment, in order to ensure aesthetic consistency and compactness, the transmission housing 186B is coaxial with the output housing 113B. In some embodiments, a rotation axis of the transmission housing 186B is parallel to but does not coincide with the output axis 104. In some embodiments, the rotation axis of the transmission housing 186B intersects with the output axis 104.

Exemplarily, the first intermediate gear 185B includes a fan-shaped gear that is driven to swing about the third axis 103 to and fro, thereby driving the output shaft 131 to switch between the first position and the second position. Optionally, the fan-shaped gear is an external gear. The transmission housing 186B is circumferentially provided with first internal teeth 1861B. In this embodiment, the first internal teeth 1861B are connected to external teeth of the first intermediate gear 185B through an idle gear 187B. The idle gear 187B is disposed between the first internal teeth 1861B and the first intermediate gear 185B. The idle gear 187B rotates about an idle gear 187B axis. Optionally, the transmission housing 186B rotates along a first direction. The first internal teeth 1861B drive the idle gear 187B to rotate along the first direction. The idle gear 187B is engaged with the external teeth of the first intermediate gear 185B, to drive the first intermediate gear 185B to rotate along a second direction. By adding the idle gear 187B in a transmission path from the transmission housing 186B to the first intermediate gear 185B, operation of the user is smoother.

For power transmission from the transmission shaft 141 to the output shaft 131, the input portion 181B includes a driving gear 1811B. The driving gear 1811B is an external gear. The output portion 182B includes a driven gear 1821B. The driven gear 1821B is an external gear. The output portion 182B is coaxial with the output shaft 131, i.e., the output portion 182B rotates about the output axis 104. A second intermediate gear 188B is disposed between the input portion 181B and the output portion 182B, such that the output portion 182B rotates in a same direction as the transmission shaft 141. In this embodiment, the second intermediate gear 188B rotates about the third axis 103. That is, the first intermediate gear 185B is coaxial with the second intermediate gear 188B to ensure compactness of the product. The second intermediate gear 188B is an external gear. The input portion 181B is externally engaged with the second intermediate gear 188B. The second intermediate gear 188B is externally engaged with the output portion 182B. The output portion 182B is driven by the first intermediate gear 185B to rotate about the third axis 103 along a periphery of the second intermediate gear 188B. That is, when the output shaft 131 is switched between the first position and the second position, the output portion 182B is engaged with the second intermediate gear 188B.

A displacement limiting groove 1132B is formed in the output housing 113B. The displacement limiting groove is configured to indicate the first position and the second position of the output shaft 131. Exemplarily, the displacement limiting groove 1132B limits a displacement end point of the output shaft 131. Exemplarily, the displacement limiting groove 1132B limits a displacement of the transmission housing 186B relative to the first intermediate gear 185B, preventing disengagement of the transmission housing 186B with a rack of the first intermediate gear 185B.

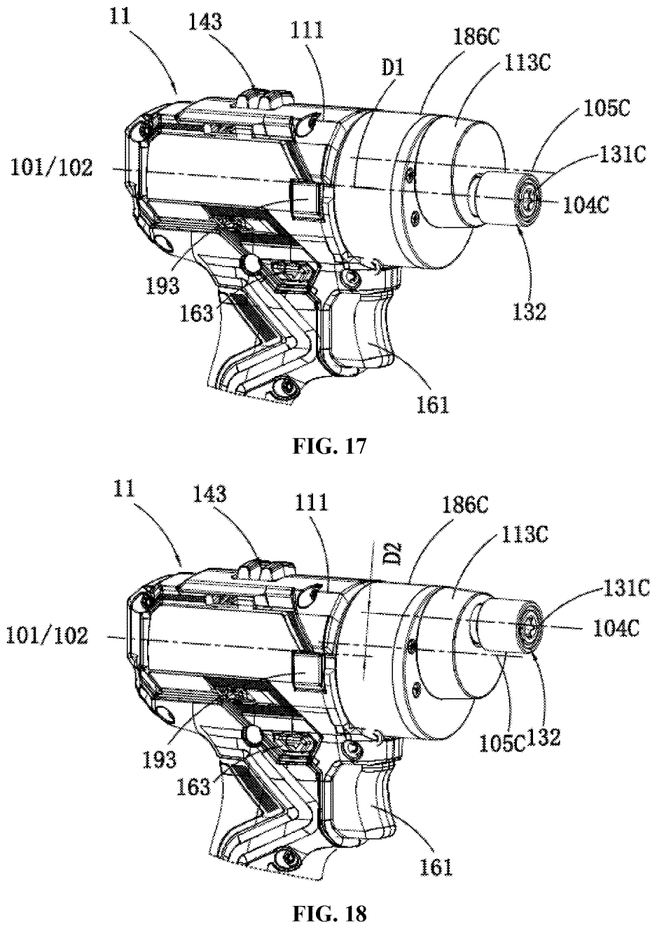

As shown in FIGS. 17 to 20, a third embodiment of the present disclosure provides an electric drill. Features and elements corresponding to those of the electric drill 100 are denoted by similar reference numerals followed by the letter “C”. Identical features have same reference numerals as Embodiment 1. The following descriptions focus on differences between the third embodiment and the first embodiment.

Referring to FIG. 7, the handheld power tool includes: a motor 12 that includes a drive shaft 121 rotating about a first axis 101; and a drive housing 111 that at least accommodates the motor 12.

As shown in FIG. 17, the handheld power tool further includes: an output shaft 131C that defines an output axis 104C, the output shaft 131C rotating about the output axis 104C to output power; and an output housing 113C that is configured to support rotation of the output shaft 131C. The output housing 113C defines a first central axis 105C passing through a geometric center. The output axis 104C is offset relative to the first central axis 105C. The output housing 113C rotates relative to the drive housing 111 about the first central axis 105C, such that the output shaft 131C rotates relative to the drive housing 111 about the first central axis 105C.

The output shaft 131C rotates about the first central axis 105C to switch between a first position and a second position. When the output shaft 131C is at the first position, a radial distance from the output axis 104C to the first axis 101 is D1. When the output shaft 131C is at the second position, the radial distance from the output axis 104C to the first axis 101 is D2. D1 is less than D2. In this embodiment, when the output shaft 131C is at the first position, the output axis 104C is substantially coaxial with the first axis 101. When the output shaft 131C is at the second position, the output axis 104C is radially offset from the first axis 101. By offsetting the output axis 104C from the first central axis 105C of the output housing 113C, the output shaft 131C can be switched between a first state (a “central” state of the output shaft 131C) in which the output axis 104C is substantially coaxial with the first axis 101 and a second state (an offset “edge-following” state of the output shaft 131C) in which the output axis 104C is offset from the first axis 101, to realize edge-following work.

In some alternative embodiments, the first position and the second position of the output shaft 131C correspond to two different offset edge-following states of the output shaft 131C. At this time, it is to be understood that when the output shaft 131C is at the first position and the output shaft 131C at the second position, the electric drill 100 is in the second state (the offset edge-following state of the output shaft 131).

In some embodiments, referring to FIG. 7, the handheld power tool further includes a transmission mechanism 14 that is configured to connect the drive shaft 121. The transmission mechanism 14 is provided with a transmission shaft 141 defining a second axis 102.

The output shaft 131C rotates about the first central axis 105C to switch between the first position and the second position. When the output shaft 131C is at the first position, a radial distance from the output axis 104C to the second axis 102 is D1. When the output shaft 131C is at the second position, the radial distance from the output axis 104C to the second axis 102 is D2. D1 is less than D2. In this embodiment, the output axis 104C is substantially coaxial with the second axis 102 when the output shaft 131C is at the first position. The output axis 104C is radially offset from the second axis 102 when the output shaft 131C is at the second position. By offsetting the output axis 104C from the first central axis 105C of the rotating central shaft, the output shaft 131C can be switched between a first state (a “central” state of the output shaft 131C) in which the output axis 104C is substantially coaxial with the second axis 102 and a second state (an offset “edge-following” state of the output shaft 131C) in which the output axis 104C is offset relative to the first axis 101, to realize edge-following work. In this embodiment, the first central axis 105C is offset from the second axis 102.

In some alternative embodiments, the first position and the second position of the output shaft 131C correspond to two different offset edge-following states of the output shaft 131C. At this time, it is to be understood that when the output shaft 131C is at the first position and the output shaft 131C at the second position, the electric drill 100 is in the second state (the offset edge-following state of the output shaft 131).

In this embodiment, the second axis 102 coincides with the first axis 101. In some embodiments, the second axis 102 is parallel to but does not coincide with the first axis 101. In some embodiments, the second axis 102 intersects with the first axis 101. In some embodiments, if the drive shaft 121 directly drives the output shaft 131C, the “central” state of the output shaft 131C and the offset “edge-following” state of the output shaft 131C are relative to the drive shaft 121. In some embodiments, the drive shaft 121 does not directly drive the output shaft 131C. Power of the drive shaft 121 is transmitted to the output shaft 131C through the transmission mechanism 14. That is, a power output end of the output shaft 131C is provided with the transmission shaft 141, such that the “central” state of the output shaft 131C and the offset “edge-following” state of the output shaft 131C are relative to the transmission shaft 141.

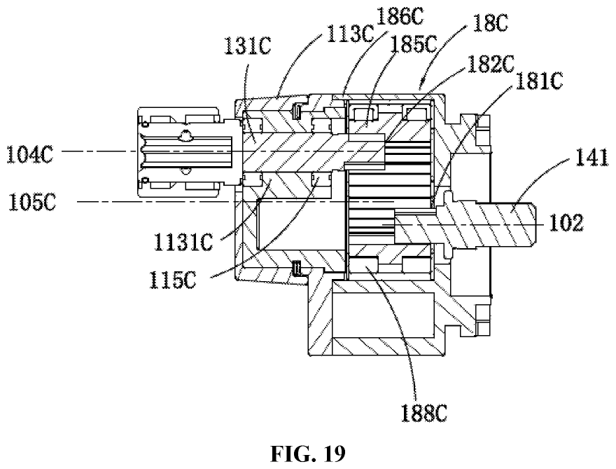

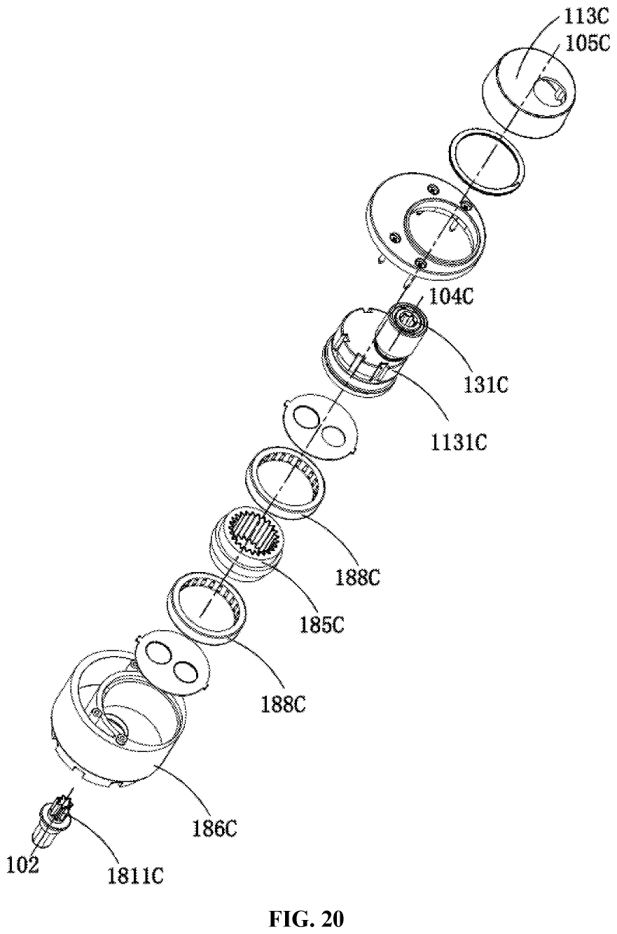

In this embodiment, as shown in FIGS. 19 to 20, the handheld power tool further includes an output transmission assembly 18C that is disposed between the transmission shaft 141 and the output shaft 131C. The output transmission assembly 18C includes an input portion 181C configured to input power and an output portion 182C connected to the output shaft 131C. Exemplarily, the input portion 181C is connected to the transmission shaft 141. When the output shaft 131C is at the second position, the output portion 182C is offset from the input portion 181C. In this embodiment, when the output shaft 131C is at the first position, the output axis 104C is substantially coaxial with the second axis 102, and the output portion 182C is substantially coaxial with the input portion 181C.

In some embodiments, the output transmission assembly 18C further includes a first inner toothed ring 185C. The input portion 181C and the output portion 182C are engaged with the first inner toothed ring 185C. The output transmission assembly 18C includes a transmission housing 186C. The transmission housing 186C is rotatably connected to the output housing 113C. The first inner toothed ring 185C is at least partially disposed in the transmission housing 186C. For power transmission from the transmission shaft 141 to the output shaft 131C, the input portion 181C includes a driving gear 1811C. The driving gear 1811C is an external gear. The output portion 182C includes a driven gear. The driven gear is an external gear. The output portion 182C is coaxial with the output shaft 131C, i.e., the output portion 182C rotates about the output axis 104C. The driving gear 1811C drives the first inner toothed ring 185C to rotate, thereby driving the output portion 182C to rotate. Exemplarily, a bearing 188C is disposed outside the inner toothed ring. The bearing 188C supports rotation of the first inner toothed ring 185C. Optionally, the bearing 188C is supported in the transmission housing 186C. In this embodiment, the transmission shaft 141 drives the first inner toothed ring 185C through the driving gear 1811C to rotate. The output portion 182C is engaged with the first inner toothed ring 185C, and thus the first inner toothed ring 185C drives the output portion 182C to rotate. The output portion 182C drives the output shaft 131C to rotate relative to the output housing 113C about the output axis 104C, thereby outputting torque.

In this embodiment, a central axis of the first inner toothed ring 185C is substantially coaxial with the first central axis 105C. When the output shaft 131C is switched between the first position and the second position, the output portion 182C rotates about the first central axis 105C along internal teeth of the first inner toothed ring 185C. Exemplarily, when the output shaft 131C is switched between the first position and the second position, the first inner toothed ring 185C does not rotate, and the output portion 182C is engaged with the first inner toothed ring 185C.

In this embodiment, the output housing 113C is provided with an accommodating portion 1131C. A first bearing 115C configured to support rotation of the output shaft 131C about the output axis 104C is sleeved on the output shaft 131C. Exemplarily, there are two first bearings 115C that are disposed in front of the output portion 182C.

The above shows and describes the basic principles, main features, and advantages of the present application. Those skilled in the art should understand that the above embodiments are not intended to limit the present disclosure in any form, and that any technical solutions obtained by means of equivalent replacement or equivalent transformation should fall within the protection scope of the present disclosure.

What is claimed is:

1. A handheld power tool, comprising:
a motor comprising a drive shaft rotating about a first axis;
a drive housing at least accommodating the motor;
an output shaft rotating about an output axis to output power; and
an output housing that supports rotation of the output shaft, the output housing defining a first central axis passing through a geometric center of the output housing; wherein a radial distance from the first central axis to an outer edge of the output housing is R;
wherein the output shaft comprises a first position and a second position; when the output shaft is at the first position, a radial distance from the output axis to the first central axis is D1; and when the output shaft is at the second position, the radial distance from the output axis to the first central axis is D2, D1 is less than D2, D1 is greater than or equal to 0 and less than R, and D2 is greater than 0 and less than or equal to R.

2. The handheld power tool according to claim 1, wherein the output housing rotates relative to the drive housing about the first central axis.

3. The handheld power tool according to claim 1, wherein when the output shaft is at the second position, the output shaft rotates relative to the drive housing about the first central axis.

4. The handheld power tool according to claim 1, further comprising a first locking portion that retains the output shaft at the first position or the second position.

5. The handheld power tool according to claim 1, wherein when the output shaft is at the first position, the output shaft rotates relative to the drive housing about the first central axis.

6. The handheld power tool according to claim 1, wherein the output shaft is provided with or connected to a clamping portion for connecting a working component; and the working component is configured to implement a function of the handheld power tool.

7. The handheld power tool according to claim 1, further comprising a first bearing that supports rotation of the output shaft about the output axis, wherein the output housing is provided with an accommodating portion; and the accommodating portion accommodates the first bearing.

8. The handheld power tool according to claim 2, further comprising a second locking assembly that selectively locks rotation of the output housing relative to the drive housing.

9. The handheld power tool according to claim 1, wherein the output shaft rotates relative to the output housing about a third axis to switch between the first position and the second position; and the third axis is eccentric to the first central axis.

10. The handheld power tool according to claim 1, further comprising a transmission mechanism that connects the drive shaft and the output shaft, wherein the transmission mechanism is provided with a transmission shaft defining a second axis; the transmission shaft drives the output shaft; and when the output shaft is at the first position or the second position, the output axis is radially offset from the second axis.

11. The handheld power tool according to claim 10, further comprising a second housing that rotates relative to the drive housing, wherein when the handheld power tool is in an offset state where the output axis is radially offset from the second axis, a position of the output axis relative to the second axis is adjusted by rotating the second housing; and a length from a rear end of the second housing to an end of the output shaft extending out of the second housing is less than or equal to 56 mm.

12. The handheld power tool according to claim 10, wherein a working state of the handheld power tool comprises a first state where the output axis is substantially coaxial with the second axis and a second state where the output axis is radially offset from the second axis; and when the handheld power tool is in the first state, the output axis is substantially coaxial with the first central axis.

13. The handheld power tool according to claim 10, further comprising a clutch assembly, wherein the clutch assembly is connected between the transmission shaft and the output shaft; and the clutch assembly is selectively connected to the transmission shaft and the output shaft at the first position, or the transmission shaft and the output shaft at the second position.

14. The handheld power tool according to claim 13, wherein the clutch assembly comprises an engaged state for torque transmission between the transmission shaft and the output shaft and a disengaged state for transmission interruption between the transmission shaft and the output shaft; and when the clutch assembly is in the disengaged state, the output shaft is configured to move in a direction perpendicular to the first axis.

15. The handheld power tool according to claim 14, wherein when the clutch assembly is in the disengaged state, the output shaft is switched between the first position and the second position.

16. A handheld power tool, comprising:
a motor comprising a drive shaft rotating about a first axis;
a drive housing at least accommodating the motor;
an output shaft rotating about an output axis to output power; and
an output housing that supports rotation of the output shaft, the output housing defining a first central axis passing through a geometric center of the output housing;
wherein the output shaft comprises a first position and a second position; when the output shaft is at the first position, a radial distance from the output axis to the first central axis is D1; and when the output shaft is at the second position, the radial distance from the output axis to the first central axis is D2, and D1 is not equal to D2.

17. A handheld power tool, comprising:
a motor comprising a drive shaft rotating about a first axis;
a drive housing at least accommodating the motor;
an output shaft rotating about an output axis to output power; and
an output housing that supports rotation of the output shaft, the output housing defining a first central axis passing through a geometric center of the output housing; wherein the output shaft moves relative to the output housing, wherein the output axis is radially offset relative to the first central axis.

18. The handheld power tool according to claim 17, wherein the output shaft rotates relative to the output housing about a third axis; and the third axis is eccentric to the first central axis.

19. The handheld power tool according to claim 17, wherein the output shaft is provided with or connected to a clamping portion for connecting a working component; and the working component is configured to implement a function of the handheld power tool.

20. The handheld power tool according to claim 17, further comprising a first bearing that supports rotation of the output shaft about the output axis, wherein the output housing is provided with an accommodating portion; and the accommodating portion is configured to accommodate the first bearing.
